(19) United States
(12) Patent Application Publication
(10) Pub. No.: US 2007/0236735 A1
(43) Pub. Date: Oct. 11, 2007

(54) Print by Object for Hand Printers

(76) Inventor: William Henry Reed, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/278,976

(22) Filed: Apr. 7, 2006

(51) Int. Cl. G06K 15/00

(52) U.S. Cl. 358/1.18

(57) ABSTRACT

Methodology for preparing print jobs for hand printer. Pages are parsed into objects that are printed separately and thus reduce the requirement for navagational accuracy that is required for printing complete pages. When each object is printed, a target mark applied to the page allows the user to position the hand printer for the next object to be printed. This enables design of hand printers with lower cost position sensors.

### BACKGROUND OF THE INVENTION

This invention relates to handheld printing devices and/or random-motion printing devices, and specifically to a methodology for parsing page content into multiple objects or regions, each of which are to be printed separately by the handheld or random-motion printing device, to obtain a print output quality that maintains sufficient alignment over the page to be acceptable.

Most digital printers operate by moving paper past the printing element. This is true for “page printers,” which have an active print zone extending across the full width of the paper, and for “serial printers,” which move the print element across the paper width in addition to moving the paper lengthwise past the print element. This relative movement of paper and print element is the traditional configuration for digital printers. An alternative approach to digital printing is to fix the position of the paper while the print element is moved over the paper during printing. An example of this approach is the flatbed plotter, where the movement of the print element is controlled by fixed mechanical references along and outside the paper edges.

In recent years, a new category of printer called a “hand printer” has appeared, and these printers can be moved manually over a sheet of paper or other substrate onto which a visible image is to be printed without mechanical linkage and without mechanical control from a fixed reference point. This category of printer has the advantage of potential for compact size, which makes it attractive for mobile printing applications.

A significant factor in printer design is the accuracy of positioning the print element relative to the paper during the printing process, due to its effect on resulting print quality. Position sensors are often adopted to “close the loop” and confirm the location of the print element relative to the page. These sensors typically detect rotation of paper feed rolls or lateral travel of the carrier for the print element. In a hand printer, however, the lack of a mechanical linkage or mechanical control from a fixed reference point presents a difficulty in obtaining proper alignment with the page. A viable hand printer should be capable of matching/aligning multiple swaths of the printhead into a complete page. Without precise position sensing, small errors will accumulate until the print quality is unacceptable, especially if the operator attempts to return to an earlier print position on the page. It is generally believed that a hand printer cannot continue if the location on the page is lost. Some prior art focuses on an accurate means to determine position of the print element relative to the paper, but such designs require expensive optical elements and may not always produce reliable results.

What is desired is a means to lower the demand for determining position of the print element in a hand printer relative to the substrate, while obtaining a print output quality that maintains sufficient alignment over the page to be acceptable. The present invention addresses this concern and provides a novel approach to achieving proper alignment of the print output on the page.

### SUMMARY

The present invention provides a methodology for preparing print jobs for hand printer where pages can be parsed into objects that are printed separately, thereby reducing the requirement for navigational accuracy that is required for printing complete pages. When each object is printed, a target mark applied to the page allows the user to position the hand printer for the next object to be printed. This enables design of hand printers with lower cost position sensors.

Accordingly, it is a first aspect of the present invention to provide a method for printing a page, including: (a) with the assistance of a computerized system, parsing a page's content into a plurality of objects, each object representing a visual image to be printed on a portion of the page; (b) manually positioning a printing device on the page such that the printing device is aligned with a predetermined reference; (c) from such alignment, manually moving the printing device over a first portion of the page, wherein the printing device prints a visual image associated with a first object of the page; (d) applying a target on the page by the printing device, the target providing a reference point for a next object to be printed by the printing device; (e) manually positioning the printing device on the page such that the printing device is aligned with the target; (f) from such alignment, manually moving the printing device over a next portion of the page, wherein the printing device prints a visual image associated with a next object of the page; (g) repeating steps (d) through (f) until the plurality of objects have been printed.

In detailed embodiments, the predetermined reference in step (b) can include at least one edge of the page or at least one visual marking on the page. In an alternate detailed embodiment, the step (d) of applying a target on the page includes a step of printing a target symbol on the page. The target symbol can include at least one straight line segment, an orthogonal crosshair symbol printed on the page, or the target symbol can be a portion of the visual image associated with an object of the page. The location at which the target is applied in step (d) can be determined, at least in part, from the boundary of the present object being printed, or from the boundary of the next object to be printed. In an alternate detailed embodiment, the method further includes, following step (a), buffering the plurality of objects into a queue accessible by the printing device. The order of objects buffered into the queue can be based upon the order that the objects will be printed by the printing device, or from the location that the objects will be printed on the printed page relative to one another.

It is a second aspect of the present invention to provide a method for printing a page, the page's content comprising a plurality of objects where each object represents a visual image to be printed on a portion of the page, the method including: (a) manually moving the printing device over a first portion of the page, wherein the printing device prints a visual image associated with a first object of the page; (b) applying a target on the page by the printing device, the target providing a reference point for a next object to be printed by the printing device; (c) manually positioning the printing device on the page such that the printing device is aligned with the target; (d) from such alignment, manually moving the printing device over a next portion of the page, wherein the printing device prints a visual image associated with a next object of the page; and (e) repeating steps (b) through (d) until the plurality of objects have been printed.

The second aspect of the present invention can be practiced with the same embodiments and features described above with respect to the first aspect. In another detailed embodiment, the method further includes establishing a separate printing coordinate system for each of the objects; and the location at which the target is applied in step (b) is determined, at least in part, from the location of the coordinate system for the next object to be printed with respect to the coordinate system of the present object being printed.

It is a third aspect of the present invention to provide a computerized, or computer-assisted method for preparing a page to be printed by a handheld printer, the page comprising a plurality of objects respectively representing a visual image to be printed on a portion of the page, the method including: (a) establishing a separate printing coordinate system for each of the objects; (b) selecting a first coordinate system corresponding to a first object to be printed; (c) locating on the first coordinate system a locus of a next coordinate system corresponding to a next object to be printed, thereby linking the next coordinate system to the first coordinate system, wherein the location of locus of the next coordinate system corresponds to the relative locations between the first object and the next object on the printed page; (d) selecting the next object as the present object to be printed; (e) locating on a present coordinate system corresponding to the present object to be printed a locus of a next coordinate system corresponding to a next object to be printed, thereby linking the next coordinate system to the present coordinate system, wherein the location of the locus of the next coordinate system corresponds to the relative locations between the present object and the next object on the printed page; and (f) repeating steps (d) and (e) for the remaining plurality of objects.

The third aspect of the present invention can be practiced with the same embodiments and features described above with respect to the first and second aspects. In another detailed embodiment, the method further includes, for each located locus in steps (c) and (e), associating a target to be applied to the page during or after the printing of the corresponding object. Alternately, the method can include buffering the plurality of objects into a queue accessible by the handheld printer in order according to the sequence in which respective coordinate systems are linked in steps (c) and (e).

These and other aspects and embodiments will be apparent from the following description, the accompanying drawings, and the appended claims.

### BRIEF DESCRIPTION OF THE DRAWINGS

FIGS. 1(a) and 1(b) depict an example page content parsed into multiple objects or regions for printing, according to an exemplary embodiment of the present invention.

FIGS. 2(a) through 2(g) depict an example of printing of the multiple content objects of the page using target symbols printed on the page to align the hand printer, according to an exemplary embodiment of the present invention.

### DETAILED DESCRIPTION

In an exemplary embodiment, the present invention defines a methodology for preparing print jobs so that an improved hand printer can be produced with lower cost position sensors, while obtaining a print output quality that maintains sufficient alignment over the page to be acceptable. Print jobs on conventional printers are parsed into individual batches of content, usually hounded by the page (in most cases, a page is the same size as common office papers such as 8½×11 or A4 letter sizes). Adopting the page as the unit of content for a hand printer requires that the complete page be completed in one operation relying on an initial positional reference (such as the corner of the page). Any errors in position that are introduced during the printing operation (such as by the user's hand not moving perfectly parallel to the page edge) propagates as the print unit is moved along the page. As such errors propagate, the printer's actual position on the page will eventually deviate from the pixel location that is being printed, leading to misalignment of the printed image on the page.

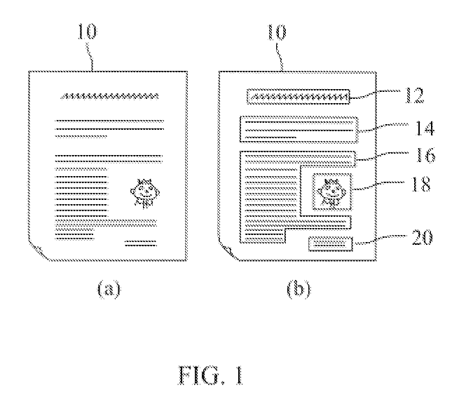

The present invention takes advantage of the fact that most printed pages are composed of islands of content separated by seas of white space, as depicted in FIG. 1(a). For purposes of this description, a “page” can be a piece of paper or any other substrate or surface on which visible markings can be made by a printer. In an exemplary embodiment, a page to be printed is parsed into multiple objects or regions, each printed completely before the operator moves to the next object on the page. For example, a page of text might be broken into multiple objects along paragraph boundaries; or a page of text and images might be broken into multiple objects along boundaries corresponding to blocks of text and individual images. In such an example, each object is printed entirely before moving on to the next object. FIG. 1(b) depicts the page 10 parsed into multiple text-block and image objects 12, 14, 16, 18, and 20. Because each of the individual objects is considerably smaller than the page itself, the total travel of the print element within the object is much smaller than for a complete page, and reduced travel distance means less navigational error.

In some embodiments, the steps for processing the page to be printed, such as the steps for defining the objects described below, occur in a microprocessor-based computerized system, which may be resident on a computer (desktop, laptop, handheld or otherwise) preparing the print-job, on the hand held printer itself, on a web-server or any other type of computer or computerized system as will be known or available to those of ordinary skill in the art. It is also within the scope of the invention that multiple computerized systems may be utilized to perform various steps of the disclosed method.

Steps or methods for breaking a page into objects are numerous and well known in the art. For example, many page description languages define a page according to separate objects to be printed on the page. The present invention may utilize the objects as pre-defined by the page description language, may combine certain of the pre-defined objects into larger objects to avoid having too many objects to be separately printed on the page (for example), and/or may break up certain of the pre-defined objects into smaller objects to avoid having objects that are too large (for example).

It is also within the scope of the invention, that the page may be defined as a single object (such as a bitmap or the like) and the present invention breaks this single object into smaller objects (such as smaller bitmaps) for printing according to an embodiment of the present invention. A first step in breaking up this larger object into smaller objects is to select a way in which boundaries between the smaller objects are identified. As will be shown below, one such method for identifying boundaries between smaller objects within a larger object is to define the smaller objects according to white-spaces (or other null-spaces, which may be any common background color or grayscale tone) between the smaller objects. Once the smaller objects are identified according to such white-spaces, a larger object is broken into a plurality of smaller objects, which may be all of the smaller objects bounded by the white-spaces or comprise fewer or more objects according to other considerations, such as those mentioned above.

It is also within the scope of the invention that the page may be broken up into multiple objects for printing with the assistance of a graphical user interface on a user's computer. In such embodiments, a graphical user interface may allow the user to manually select/identify individual objects to be included in a printing operation.

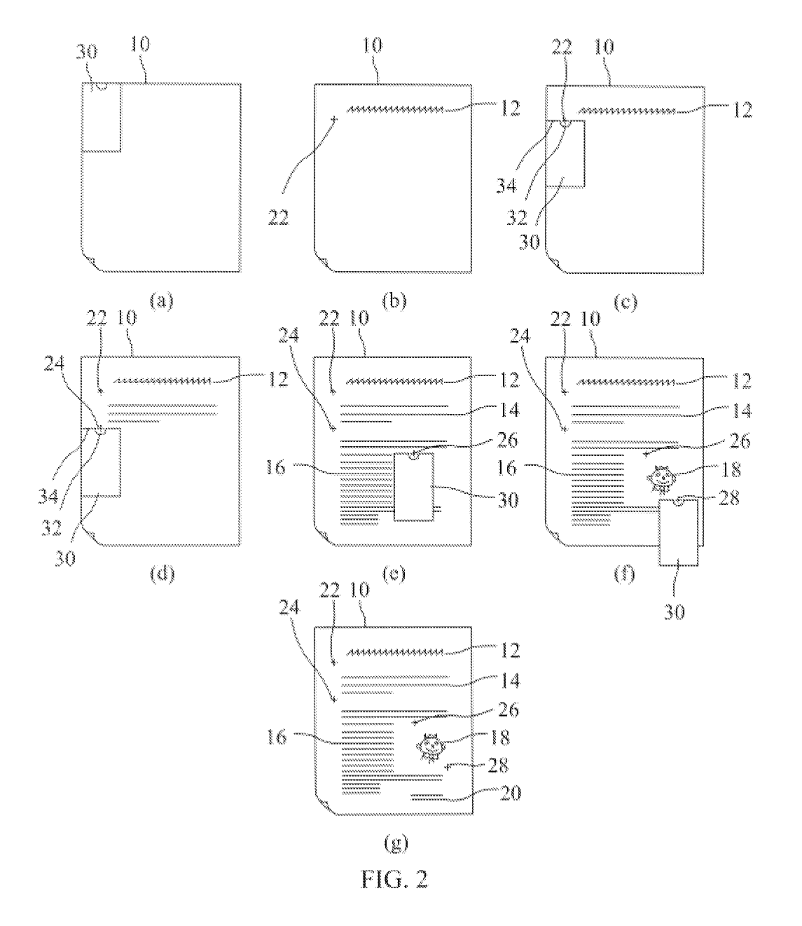

An exemplary operation of printing multiple objects of a page using a hand printer is illustrated in FIG. 2. FIG. 2(a) shows a blank page 10 ready for printing, with the hand printer 30 positioned in the page's upper left corner, parallel to the left edge and top edge of the page. Alignments of the hand printer with the page edges can be accomplished using the sides of the hand printer as a reference. Alternatively, guide marks, light guides, or other alignment devices can be used to orient the hand printer 30 parallel to the page edges.

During the print operation, the boundary between objects on the page is characterized by the opportunity to lift the printer from the print surface and start anew. In some embodiments, a print method uses multiple starting points corresponding to each new object to be printed on the page. In an exemplary embodiment, at the completion of printing a given object (or any time during the printing of a given object) the hand printer would print a visible target (such as the “+” symbol) on the page that serves as a reference with which the printer can be aligned to assist the operator in locating on a new start point for the next object to be printed. Alternatively, a visible feature within the printed object itself (such as an alphanumeric character) can be used as an alignment reference for the start point for the next object, thus eliminating the need to print extraneous alignment target symbols on the page. In an exemplary embodiment, because object boundaries are selected where islands of printed objects are separated by significant white space, the need to carefully align objects is substantially less than the corresponding requirement to align print swaths within an object.

Once a hand printer 30 is positioned in a starting position as shown in FIG. 2(a), the user can move the hand printer over the print medium, during which the hand printer will print the first object. FIG. 2(b) shows a page 10 after a first object 12 is printed. During or after the printing of the first object 12, the hand printer prints a target symbol 22 on the page within or substantially adjacent to the object 12. As mentioned above, this target symbol (and the other indicia associated with other objects, as discussed below) can be a separate symbol printed on the page solely for the purpose of providing an alignment target (such as the “+” symbol shown in the figures), or can be an integral component (such as an alphanumeric character or other visible element) of the object 12. This target symbol serves as an alignment target that enables the user to position the hand printer to initiate the printing of the next object. The location of the target symbol 22 on the page 10 with respect to the first object 12 can be determined by software and based on a relative position of other objects on the page. For example, as seen in FIGS. 2(b) through 2(d), if another object is located beneath the first object 12, then the target symbol 22 can be printed near the lower edge of the first object 12, such as near its lower left corner (as is depicted in the figures). The target symbol 22 for the next object may be added to the present object during the process of breaking the page into multiple objects, or the target symbol 22 may be located and printed separately by the hand printer.

As will be apparent to those of ordinary skill in the art, in some embodiments, the coordinate system for printing each subsequent object can be based upon the target symbol corresponding to such object, rather than the coordinate system for the previous target. Such navigation targets may be printed in permanent or temporary ink. In alternative embodiments, a printer may mark the page with a non-printed navigation target, such as an impression made into the substrate or a removable object or dot that is applied to the substrate. An example of such a non-printed target may include a small, temporary impression made into the substrate by a pointed prong disposed on and actuated by the printer.

Once the first object 12 and the accompanying target symbol 22 have been printed, the user can align the hand printer 30 with the target symbol 22 in preparation for printing the next object on the page. FIG. 2(c) shows the hand printer 30 aligned with the target symbol 22. This alignment can be accomplished by using part of the hand printer 30, such as a notch 32 or side 34 of the hand printer 30, as a reference. Alternatively, guide marks, light guides, or another alignment device can be used to align the hand printer 30 with the target symbol 22. Once the hand printer 30 is properly aligned with the target symbol 22, the user can move the hand printer over the page, during which the hand printer will print the second object on the page. FIG. 2(d) shows the page 10 after the second object 14 has been printed. During or after the printing of the object 14, the hand printer prints a target symbol 24 on the page within or close to the object 14. As with the first target symbol 22 discussed above, this second target symbol 24 will serve as an alignment target that enables the user to position the hand printer before the next object is printed. In FIG. 2(d), the hand printer 30 is shown aligned with this target symbol 24.

Once the hand printer 30 is properly aligned with the target symbol 24, the user can move the hand printer across the page, during which the hand printer will print the third object on the page. FIG. 2(e) shows the page 10 after the third object 16 has been printed. During or after the printing of the object 16, the hand printer prints a target symbol 26 on the page within or close to the object 16, and this target symbol 26 will serve as an alignment target that enables the user to position the hand printer 30 before the next object is printed, as shown in FIG. 2(e).

Once the hand printer 30 is properly aligned with the target symbol 26, the user can move the hand printer across the page, during which the hand printer will print the fourth object on the page. FIG. 2(f) shows the page 10 after the fourth object 18 has been printed. During or after the printing of the object 18, the hand printer prints a target symbol 28 on the page within or close to the object 18, and this target symbol 28 will serve as an alignment target that enables the user to position the hand printer 30 before the next object is printed, as shown in FIG. 2(f).

Once the hand printer 30 is properly aligned with the target symbol 28, the user can move the hand printer across the page, during which the hand printer will print the fifth object on the page. FIG. 2(g) shows the page 10 after the fifth object 20 has been printed. Because our sample page in the exemplary embodiment depicted in FIGS. 1 and 2 contains five objects 12, 14, 16, 18, and 20, the page has now been completely printed. As seen in FIG. 2(g), the finished page includes the five objects or regions 12, 14, 16, 18, and 20, and the target symbols 22, 24, 26, and 28 that were printed on the page during the printing process.

In some embodiments, a print quality or mode can be adjusted on an object-by-object basis. Different types of objects or visual images to be printed can have different levels of acceptable defects. In some embodiments, the hand printer may be configured to analyze an object and use such analysis to aid the user in printing the object. In order to achieve the desired level of quality, the operator may be alerted to make more passes or to move the hand printer more slowly or more carefully to avoid rotation during the printing process.

In an exemplary embodiment, each page in a print job can be processed by the print driver or print application and parsed into objects as described above. In some embodiments, each object is sequentially formatted into a data buffer that is accessed by the print scheduler functionality of the print controller. As the hand printer is moved over the medium, position is compared with the data in the buffer and the print element is fired whenever an unprinted area in the latent image is traversed. When all data in the object (including the target symbols that serve to locate the start point for the next object) has been printed, the next object is released into the print buffer. This process repeats until the page is completed.

Having described the invention with reference to embodiments, it is to be understood that the invention is defined by the claims, and it is not intended that any limitations or elements describing the embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method for printing a page, comprising:
(a) with the assistance of a computerized system, parsing a page's content into a plurality of objects, each object representing a visual image to be printed on a portion of the page;
(b) manually positioning a printing device on the page such that the printing device is aligned with a predetermined reference;
(c) from such alignment, manually moving the printing device over a first portion of the page, wherein the printing device prints a visual image associated with a first object of the page;
(d) applying a target on the page by the printing device, the target providing a reference point for a next object to be printed by the printing device;
(e) repositioning the printing device on the page such that the printing device is aligned with the target;
(f) from such alignment, manually moving the printing device over a next portion of the page, wherein the printing device prints a visual image associated with a next object of the page;
(g) repeating steps (d) through (f) until the plurality of objects have been printed.

2. The method of claim 1, wherein
the predetermined reference in step (b) comprises at least one edge of the page.

3. The method of claim 1, wherein
the predetermined reference in step (b) comprises at least one visual marking on the page.

4. The method of claim 1, wherein
the step (d) of applying a target on the page includes a step of printing a target symbol on the page.

5. The method of claim 4, wherein
the target symbol comprises at least one straight line segment printed on the page.

6. The method of claim 4, wherein
the target symbol comprises at least one orthogonal crosshair symbol printed on the page.

7. The method of claim 4, wherein
the target symbol comprises a portion of the visual image associated with an object of the page.

8. The method of claim 1, wherein
the location at which the target is applied in step (d) is determined, at least in part, from the boundary of the present object being printed.

9. The method of claim 1, wherein
the location at which the target is applied in step (d) is determined, at least in part, from the boundary of the next object to be printed.

10. The method of claim 1, further comprising, following step (a), buffering the plurality of objects into a queue accessible by the printing device.

11. The method of claim 10, wherein
the order of objects buffered into the queue is based upon the order that the objects will be printed by the printing device.

12. The method of claim 11, wherein
the order of objects buffered into the queue is based upon, at least in part, the location that the objects will be printed on the printed page relative to one another.

13. A method for printing a page, the page's content comprising a plurality of objects where each object represents a visual image to be printed on a portion of the page, the method comprising:
(a) manually moving the printing device over a first portion of the page, wherein the printing device prints a visual image associated with a first object of the page;
(b) applying a target on the page by the printing device, the target providing a reference point for a next object to be printed by the printing device;
(c) repositioning the printing device on the page such that the printing device is aligned with the target;
(d) from such alignment, manually moving the printing device over a next portion of the page, wherein the printing device prints a visual image associated with a next object of the page; and
(e) repeating steps (b) through (d) until the plurality of objects have been printed.

14. The method of claim 13, wherein
the step (b) of applying a target on the page includes a step of printing a target symbol on the page.

15. The method of claim 13, wherein
the target symbol comprises a portion of the visual image associated with an object of the page.

16. The method of claim 13, wherein
the location at which the target is applied in step (b) is determined, at least in part, from the boundary of the present object printed.

17. The method of claim 13, further comprising establishing a separate printing coordinate system for each of the objects; and wherein the location at which the target is applied in step (b) is determined, at least in part, from the location of the coordinate system for the next object to be printed with respect to the coordinate system of the present object being printed.

18. The method of claim 13, further comprising, prior to step (a), buffering the plurality of objects into a queue accessible by the printing device.

19. The method of claim 18, wherein
the order of objects buffered into the queue is based, at least in part, upon the location that the objects will be printed on the printed page relative to one another.

20. A computerized, or computer-assisted method for preparing a page to be printed by a handheld printer, the page comprising a plurality of objects respectively representing a visual image to be printed on a portion of the page, the method comprising:
(a) establishing a separate printing coordinate system for each of the objects;
(b) selecting a first coordinate system corresponding to a first object to be printed;
(c) locating on the first coordinate system a locus of a next coordinate system corresponding to a next object to be printed, thereby linking the next coordinate system to the first coordinate system, wherein the location of the locus of the next coordinate system corresponds to the relative locations between the first object and the next object on the printed page;
(d) selecting the next object as the present object to be printed;
(e) locating on a present coordinate system corresponding to the present object to be printed a locus of a next coordinate system corresponding to a next object to be printed, thereby linking the next coordinate system to the present coordinate system, wherein the location of the locus of the next coordinate system corresponds to the relative locations between the present object and the next object on the printed page; and
(f) repeating steps (d) and (e) for the remaining plurality of objects.

21. The method of claim 20, further comprising, for each located locus in steps (c) and (e), associating a target to be applied to the page during or after the printing of the corresponding object.

22. The method of claim 20, further comprising:
buffering the plurality of objects into a queue accessible by the handheld printer in order according to the sequence in which respective coordinate systems are linked in steps (c) and (e).
